(19) United States
(12) Patent Application Publication
(10) Pub. No.: US 2026/0032306 A1
(43) Pub. Date: Jan. 29, 2026

(54) CONFIGURATION PARAMETER SHARING METHOD AND APPARATUS, ELECTRONIC DEVICE, STORAGE MEDIUM, AND PROGRAM PRODUCT

(71) Applicant: Tencent Technology (Shenzhen) Company Limited, Shenzhen (CN)

(72) Inventor: Shangzhen ZHENG, Shenzhen (CN)

(73) Assignee: Tencent Technology (Shenzhen) Company Limited, Shenzhen (CN)

(21) Appl. No.: 19/348,392

(22) Filed: Oct. 2, 2025

Related U.S. Application Data
(63) Continuation of application No. PCT/CN2024/102242, filed on Jun. 28, 2024.

(30) Foreign Application Priority Data
Sep. 11, 2023 (CN) 202311170959.5

(51) Int. Cl. H04N 21/431; H04N 21/2187; H04N 21/472

(52) U.S. Cl. CPC H04N 21/4316; H04N 21/2187; H04N 21/472

(57) ABSTRACT

A configuration parameter sharing method is provided, is executed by an electronic device, and includes: displaying a livestreaming content of a virtual livestreaming room on a live stream interface provided to a live stream host (210); displaying, in response to a configuration sharing operation, a parameter selection interface, and displaying a parameter identifier of at least one configuration parameter related to the livestreaming content on the parameter selection interface (220); and sending, in response to a selection operation for the parameter identifier in the parameter selection interface, a target configuration parameter indicated by a selected parameter identifier to audience ends used by at least some of the audiences of the virtual livestreaming room (230).

### RELATED APPLICATION

This application is a continuation of and claims the benefit of priority to PCT Application No. PCT/CN2024/102242, filed Jun. 28, 2024, and entitled CONFIGURATION PARAMETER SHARING METHOD AND APPARATUS, ELECTRONIC DEVICE, STORAGE MEDIUM, AND PROGRAM PRODUCT, which is based on and claims the benefit of priority to Chinese Patent Application No. 202311170959.5, entitled “CONFIGURATION PARAMETER SHARING METHOD AND APPARATUS, ELECTRONIC DEVICE, STORAGE MEDIUM, AND PROGRAM PRODUCT” filed on Sep. 11, 2023, which is incorporated by reference in its entirety. The above applications are incorporated herein by reference in their entireties.

### FIELD OF THE TECHNOLOGY

This application relates to the technical field of multimedia, and in particular, to a configuration parameter sharing method, a configuration parameter sharing apparatus, an electronic device, a computer-readable storage medium, and a computer program product.

### BACKGROUND OF THE DISCLOSURE

At present, various types of electronic devices such as smartphones, tablet computers, notebook computers, and desktop computers enter daily life and provide various functions for users. For example, the electronic devices may implement an audio/video playback function through an installed audio/video application, or implement a shooting function through a system shooting application or a third-party shooting application.

In order to enable the electronic device to run better, the electronic device itself or an application program installed in the electronic device generally provides a parameter configuration function. For example, for the electronic device, a user may change a display brightness of a screen by adjusting a brightness parameter of the screen, or may also change a volume level of a speaker by adjusting a volume parameter of the speaker; and for an application installed in the electronic device, the user may change a noise reduction effect of a video application by adjusting a noise reduction parameter of a video playback application, or may also change a beautification effect of the shooting application by adjusting a beautification configuration parameter of the shooting application.

However, the user is generally not a professional, and is not skilled at parameter configuration. If the configuration is performed by the professional, a great amount of labor and time may be needed, resulting in low efficiency.

### SUMMARY

Embodiments of the present disclosure provide a configuration parameter sharing method, a configuration parameter sharing apparatus, an electronic device, a computer-readable storage medium, and a computer program product.

In the first aspect, a configuration parameter sharing method provided by the present disclosure is executed by an electronic device, and includes:
displaying a livestreaming content of a virtual livestreaming room on a live stream interface provided to a live stream host;
displaying, in response to a configuration sharing operation, a parameter selection interface;
displaying a parameter identifier of at least one configuration parameter related to the livestreaming content on the parameter selection interface; and
sending, in response to a selection operation for the parameter identifier in the parameter selection interface, a target configuration parameter indicated by a selected parameter identifier to audience ends used by at least some of the audiences of the virtual livestreaming room.

In the second aspect, a configuration parameter sharing method is provided, is executed by an electronic device, and includes:
displaying a livestreaming content of a virtual livestreaming room on a live stream interface provided to an audience end;
displaying, in response to a reception of a target configuration parameter sent by a live stream host in the virtual livestreaming room, a configuration processing interface;
displaying a parameter application control on the configuration processing interface, the target configuration parameter being related to the livestreaming content; and
applying, in response to a parameter application operation for the parameter application control, the target configuration parameter.

In a third aspect, a configuration parameter sharing apparatus is provided, and includes:
a live stream host end display module, configured to display a livestreaming content of a virtual livestreaming room on a live stream interface provided to a live stream host;
a parameter display module, configured to display, in response to a configuration sharing operation, a parameter selection interface, and display a parameter identifier of at least one configuration parameter related to the livestreaming content on the parameter selection interface; and
a parameter sharing module, configured to send, in response to a selection operation for the parameter identifier in the parameter selection interface, a target configuration parameter indicated by a selected parameter identifier to audience ends used by at least some of the audiences of the virtual livestreaming room.

In a fourth aspect, a configuration parameter sharing apparatus is provided, and includes:
an audience end display module, configured to display a livestreaming content of a virtual livestreaming room on a live stream interface provided to an audience end;
a parameter processing module, configured to display, in response to a reception of a target configuration parameter sent by a live stream host in the virtual livestreaming room, a configuration processing interface, and display a parameter application control on the configuration processing interface, the target configuration parameter being related to the livestreaming content; and
a parameter execution module, configured to apply, in response to a parameter application operation for the parameter application control, the target configuration parameter.

In a fifth aspect, an electronic device provided by the present disclosure includes a memory and a processor, the memory has a computer program stored therein, and the processor is configured to run the computer program in the memory to implement operations of the configuration parameter sharing method provided by the present disclosure.

In a sixth aspect, a computer-readable storage medium provided by the present disclosure has a computer program stored therein, the computer program is suitable for being executed by the processor to implement operations of the configuration parameter sharing method provided by the present disclosure.

In a seventh aspect, a computer program product provided by the present disclosure includes a computer program or instruction, and the computer program or instruction, when executed by a processor, implements operations of the configuration parameter sharing method provided by the present disclosure.

Details of one or more embodiments of the present disclosure are provided in the accompanying drawings and descriptions below. Other features, objectives, and advantages of the present disclosure become apparent from the specification, the drawings, and the claims.

### BRIEF DESCRIPTION OF THE DRAWINGS

In order to describe the technical solution of embodiments of the present disclosure more clearly, drawings to be used in descriptions of embodiments are briefly introduced below. Apparently, drawings described hereafter are only some embodiments of the present disclosure. For those skilled in the art, other drawings may also be obtained according to these drawings without inventive efforts.

FIG. 1 is an example schematic diagram of a scenario of a configuration parameter sharing system provided by an embodiment of the present disclosure.

FIG. 2 is an example schematic flowchart of a configuration parameter sharing method provided by an embodiment of the present disclosure.

FIG. 3 is an example diagram of a live stream interface in an embodiment of the present disclosure.

FIG. 4 is an example diagram of triggering to display a sharing sub interface in an embodiment of the present disclosure.

FIG. 5 is an example diagram of triggering to display a parameter selection interface in an embodiment of the present disclosure.

FIG. 6 is an example schematic diagram of sharing a target configuration parameter to an audience end through a livestreaming server in an embodiment of the present disclosure.

FIG. 7 is an example diagram of an audience selection interface in an embodiment of the present disclosure.

FIG. 8 is another example diagram of an audience selection interface in an embodiment of the present disclosure.

FIG. 9 is another example schematic flowchart of a configuration parameter sharing method provided by an embodiment of the present disclosure.

FIG. 10 is an example diagram of a configuration processing interface in an embodiment of the present disclosure.

FIG. 11 is a further another example schematic flowchart of a configuration parameter sharing method provided by an embodiment of the present disclosure.

FIG. 12 is an example diagram of a sharing confirmation interface in an embodiment of the present disclosure.

FIG. 13 is an example schematic structural diagram of a configuration parameter sharing apparatus provided by an embodiment of the present disclosure.

FIG. 14 is another example schematic structural diagram of a configuration parameter sharing apparatus provided by an embodiment of the present disclosure.

FIG. 15 is an example schematic structural diagram of an electronic device provided by an embodiment of the present disclosure.

### DESCRIPTION OF EMBODIMENTS

The technical solution in embodiments of the present disclosure will be clearly and completely described hereinafter with reference to the accompanying drawings in the embodiments of the present disclosure. Of course, the described embodiments are only some, but not all, embodiments of the present disclosure. All other embodiments obtained by a person of ordinary skill in the art based on the embodiments of the present disclosure without making creative efforts shall fall within the protection scope of the present disclosure.

“Some embodiments” in the following descriptions of the present disclosure describes a subset of all possible embodiments. However, “some embodiments” may be same or different subsets of all the possible embodiments, and may be combined with each other when there is no conflict.

In the following descriptions of the present disclosure, the terms “first”, “second”, and “third” are merely intended to distinguish similar objects and do not indicate a specific sequence of the objects. A specific order or sequence of the “first”, “second”, and “third” may be interchanged where permitted, so that the embodiments of the present disclosure described herein may be implemented in an order other than the order illustrated or described herein.

Unless otherwise defined, all technical and scientific terms used in the present disclosure have the same meanings as those usually understood by those skilled in the art to which the present disclosure belongs. Terms used in the present disclosure are merely intended to describe objectives of the embodiments of the present disclosure, but are not intended to limit the present disclosure.

In order to improve an audio-visual effect of electronic device operation, embodiments of the present disclosure provide a configuration parameter sharing method, a configuration parameter sharing apparatus, an electronic device, a computer-readable storage medium, and a computer program product. The configuration parameter sharing method may be executed by a configuration parameter sharing apparatus, or may be executed by an electronic device integrated with the configuration parameter sharing apparatus.

The technical solution in embodiments of the present disclosure will be clearly and completely described hereinafter with reference to the accompanying drawings in the embodiments of the present disclosure. Of course, the described embodiments are only some, but not all, embodiments of the present disclosure. All other embodiments obtained by those skilled in the art based on the embodiments of the present disclosure without making creative efforts shall fall within the protection scope of the present disclosure.

Referring to FIG. 1, the present disclosure further provides a configuration parameter sharing system, as shown in FIG. 1. The configuration parameter sharing system includes an electronic device 100, and a configuration parameter sharing apparatus provided by the present disclosure is integrated in the electronic device 100. For example, when the configuration parameter sharing apparatus operates, a livestreaming content of a virtual livestreaming room is displayed on a live stream interface provided to a live stream host; in response to a configuration sharing operation, a parameter selection interface is displayed; the parameter selection interface includes a parameter identifier of at least one configuration parameter related to the livestreaming content; and in response to a selection operation for the parameter identifier in the parameter selection interface, a target configuration parameter indicated by a selected parameter identifier is sent to an audience end used by an audience of the virtual livestreaming room. The electronic device 100 may be any one device provided with a processor, such as a mobile electronic device having a livestreaming function including a smartphone, a tablet computer, a pocket computer, a notebook computer, etc., or a fixed electronic device having a livestreaming function including a desktop computer, a television, etc.

In addition, as shown in FIG. 1, the configuration parameter sharing system may further include a memory 200, configured to store relevant data in a configuration parameter sharing process. For example, the electronic device 100 stores a target configuration parameter indicated by a selected parameter identifier into the memory 200.

A schematic diagram of a scenario of a configuration parameter sharing system shown in FIG. 1 is only an example. The configuration parameter sharing system and scenario described in embodiments of the present disclosure are intended to describe the technical solutions in the embodiments of the present disclosure more clearly, and do not constitute a limitation to the technical solutions provided in the embodiments of the present disclosure. A person of ordinary skill in the art may learn that with an evolution of the configuration parameter sharing system and an emergence of new service scenarios, the technical solutions provided in the embodiments of the present disclosure are also applicable to similar technical problems.

Detailed descriptions are respectively provided below. The sequence numbers of the following embodiments are not intended to limit a preference order of the embodiments.

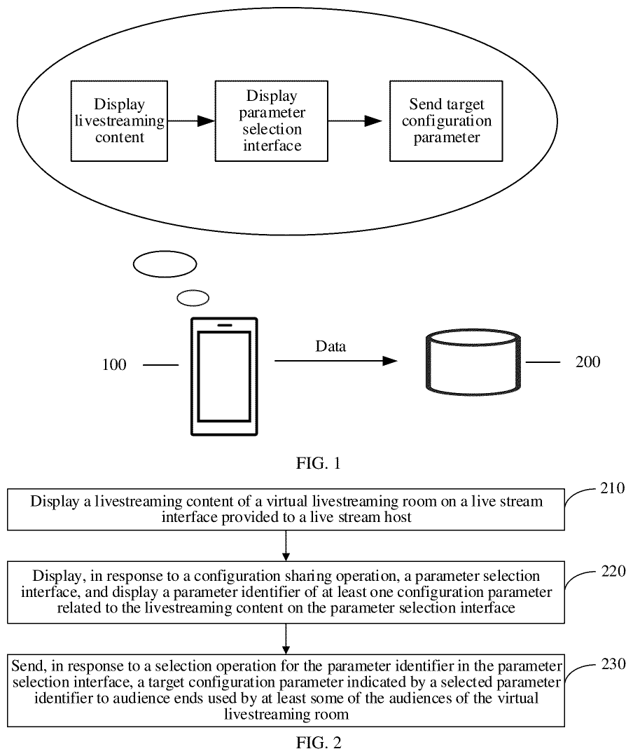

Referring to FIG. 2, FIG. 2 is a schematic flowchart of a configuration parameter sharing method provided by an embodiment of the present disclosure. In the following embodiment, an electronic device is logged in with a live stream host account of a live stream host and is used as a live stream host end to execute a configuration parameter sharing method, and as shown in FIG. 2, a flow process of the configuration parameter sharing method provided by the present disclosure is as follows:

Operation 210: A livestreaming content of a virtual livestreaming room is displayed on a live stream interface provided to a live stream host.

Livestreaming refers to a technology of collecting content data in a form of audio or video, etc., encoding and compressing the content data to form a livestreaming content capable of being perceived (in a manner of auditory perception, visual perception, etc.) and transmitted for streaming playback. The live stream host and audiences are users of different roles. The live stream host may start livestreaming through an electronic device as a live stream host end, and send a livestreaming content through a server to an electronic device as an audience end for an audience to watch through the audience end. That is, the live stream host may be a user starting the livestreaming, and the audience may be a user watching the livestreaming content of the livestreaming started by the live stream host.

The live stream host logs in a livestreaming application program running on the electronic device with the live stream host account, so that the electronic device is used as a live stream host end. The livestreaming application program refers to an application program providing a livestreaming platform for a live stream host account and providing a livestreaming video to be watched for an audience account, may be a special application program for livestreaming, and may also be a comprehensive application program integrating a livestreaming function. The comprehensive application program is an application program having various application functions. Each application function herein is an independent function of a singly developed special application program, including a livestreaming function. That is, the electronic device may be logged in with a live stream host account in the livestreaming application program in response to a user operation and start livestreaming by creating a virtual livestreaming room as an identity of a live stream host end, and may also be logged in with an audience account in the livestreaming application program and enter the virtual livestreaming room created by the live stream host end as an audience end to watch the livestreaming content of the live stream host end in a livestreaming process.

Besides sending a generated livestreaming content to the audiences in the virtual livestreaming room to realize livestreaming, the live stream host end per se also displays the livestreaming content of the virtual livestreaming room to provide real-time livestreaming feedback for the live stream host so that the live stream host masters a livestreaming effect.

Generally, the livestreaming content includes a visual content and an auditory content. Correspondingly, the live stream host end may display the visual content through a visual content display assembly (such as a screen), and display the auditory content through an auditory content display assembly.

By taking the visual content as an example, the live stream host end may display the live stream interface of the virtual livestreaming room through the visual content display assembly, and the live stream interface includes a visual content in the livestreaming content. The live stream interface is an interface capable of being configured to realize visual content display and livestreaming interaction. That is, the live stream interface may be logically divided into a livestreaming region and an interaction region. The livestreaming region is configured to display the visual content of the livestreaming content, and the interaction region is configured to display an interaction operation control realizing livestreaming interaction, such as a thumbs-up control, a comment control, and a sharing control.

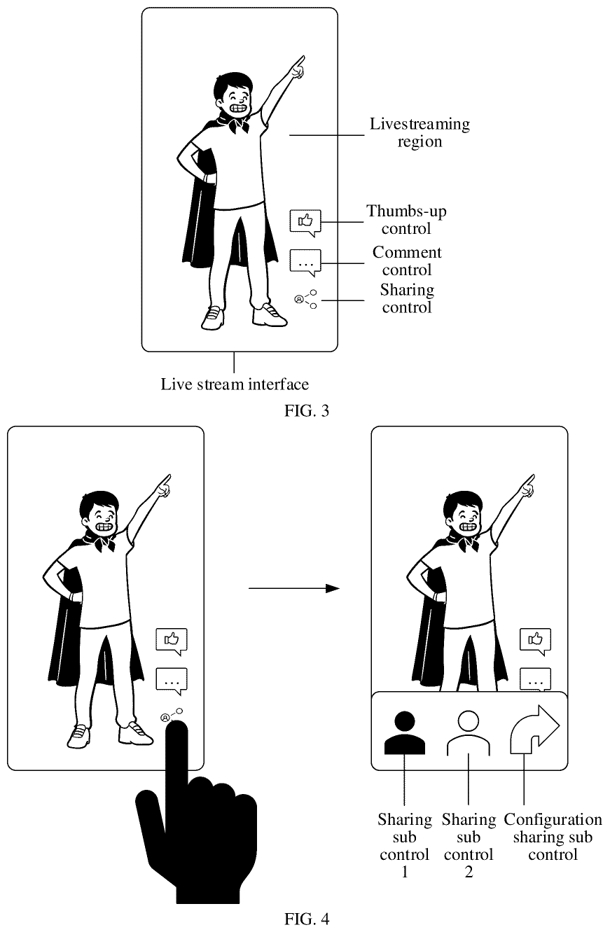

The livestreaming region and the interaction region of the live stream interface may be set in an overlapped manner, and may be set independently. For example, referring to FIG. 3, the livestreaming region and the interaction region of the live stream interface are set in an overlapped manner. The thumbs-up control, the comment control and the sharing control are set on the livestreaming region in an overlapped manner (may called as a floating manner).

Operation 220: A parameter selection interface is displayed in response to a configuration sharing operation, and a parameter identifier of at least one configuration parameter related to the livestreaming content is displayed on the parameter selection interface.

The electronic device as the live stream host end may be configured to display a parameter selection interface in response to a configuration sharing operation, and the parameter selection interface includes a parameter identifier of at least one configuration parameter related to the livestreaming content.

An operation form of the configuration sharing operation is not specifically limited in this embodiment, and includes but is not limited to a touch operation inputted based on a touchscreen provided on the live stream host end, a voice operation inputted based on a microphone provided on the live stream host end, a hardware operation of an external input device such as a mouse provided on the live stream host end, etc.

For example, referring to FIG. 3, the sharing control is configured to generate a configuration sharing operation when being triggered. When the live stream host end is provided with a touchscreen, a user may click/tap the sharing control with a limb part such as a finger to trigger and generate the configuration sharing operation, and may also click/tap the sharing control (not shown in the figure) with an external touch device such as a stylus pen to trigger and generate the configuration sharing operation; or when the live stream host end is provided with an external control device such as a mouse, the mouse may be operated to click/tap the sharing control (not shown in the figure) for triggering and generating the configuration sharing operation.

For another example, referring to FIG. 3 and FIG. 4 in a combined manner, the sharing control is configured to indicate and display a sharing sub interface when being triggered, and the sharing sub interface includes a sharing sub control 1, a sharing sub control 2, and a configuration sharing sub control. When being triggered, the sharing sub control 1 is configured to indicate to share the virtual livestreaming room to a friend user in an external application, such as an instant communication application; when being triggered, the sharing sub control 2 is configured to indicate to share the virtual livestreaming room to an information group in an external application, such as an instant communication application; and when being triggered, the configuration sharing sub control generates a configuration sharing operation. The above records of modes for generating the configuration sharing operation through the sharing control may be referred for details, and repeated descriptions are omitted herein.

Display forms of the above live stream interface, the sharing control and the sharing sub controls such as the configuration sharing sub control are not specifically limited in this embodiment, and they may be configured by those skilled in the art according to practical requirements.

In addition, in this embodiment, the parameter selection interface is displayed in response to the configuration sharing operation, the parameter selection interface is configured to provide a parameter selection function, and includes a parameter identifier of at least one configuration parameter corresponding to the livestreaming content in the virtual livestreaming room.

For example, when game livestreaming is implemented at the live stream host end, the livestreaming content at least includes a game content (including a visual content such as a game image of a game application, and an auditory content such as game background sound) of a live stream host playing the game application, and at this moment, configuration parameters capable of being shared include an application configuration parameter of the game application, and a hardware configuration parameter (such as an operation frequency of the processor, a screen brightness, and a volume level) of the live stream host end.

For another example, when chat livestreaming is implemented at the live stream host end, the livestreaming content at least includes a chat content (including a visual content such as a figure image of the live stream host, and an auditory content such as chat voice of the live stream host) of the live stream host, at this moment, the configuration parameters capable of being shared include an image acquisition configuration parameter of an image acquisition assembly, a beautification configuration parameter for beautification optimization on the image content acquired by the image acquisition assembly, an audio acquisition configuration parameter of an audio acquisition assembly, an illumination configuration parameter of an external auxiliary device such as an illumination device, etc. The image acquisition assembly may be an image acquisition assembly outside the live stream host end, and may also be an image acquisition assembly built in the live stream host end; and the audio acquisition assembly may be an audio acquisition assembly outside the live stream host end, and may also be an audio acquisition assembly built in the live stream host end.

Display modes of the parameter selection interface are not specifically limited in this embodiment, and they may be configured by those skilled in the art according to practical requirements. In one embodiment, the operation of displaying the parameter selection interface in response to the configuration sharing operation includes displaying, in response to the configuration sharing operation, the parameter selection interface through a floating window.

This embodiment provides an exemplary display mode of the parameter selection interface. When the configuration sharing operation is triggered, in response to this configuration sharing operation, the parameter selection interface is displayed in an overlapped manner on the live stream interface of the virtual livestreaming room in a form of a floating window, allowing the live stream host to select a configuration parameter to be shared. The parameter selection interface is displayed through the floating window, so the live stream host may be timely and observably prompted without excessive interference on the live stream interface. A display parameter of the floating window, such as a display position, a display style, mobility, and transparency, may be defined according to requirements.

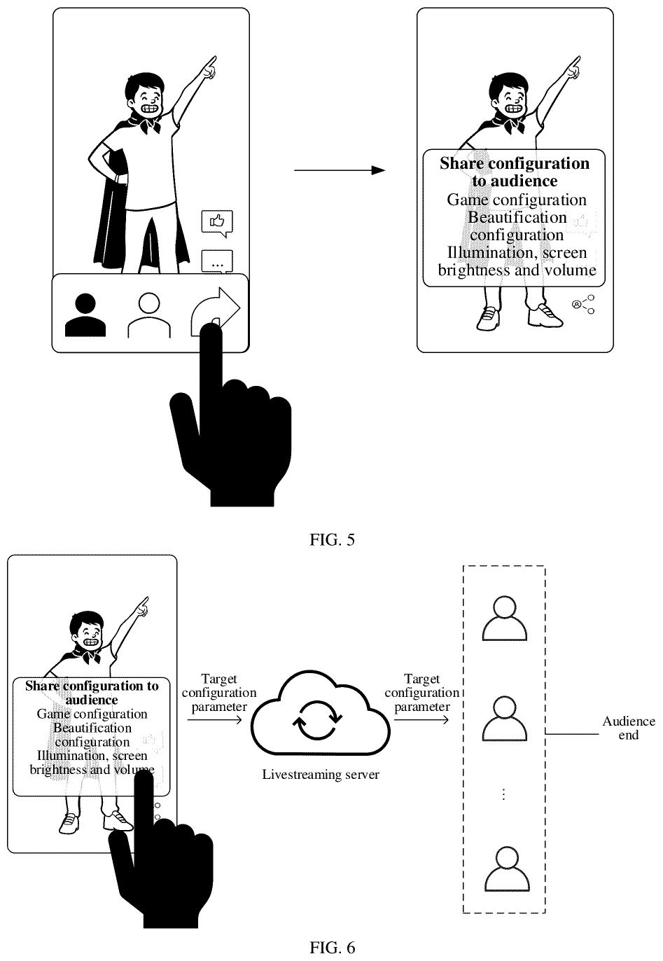

Exemplarily, referring to FIG. 5, a parameter selection interface displayed in a form of a floating window is shown. As shown in FIG. 5, this parameter selection interface is overlapped on the visual content of the live stream interface in a form of the floating window, a parameter identifier of three configuration parameters capable of being shared at present are shown, and they are respectively “game configuration” corresponding to a game application configuration parameter of the current livestreaming at the live stream host end, “beautification configuration” corresponding to a beautification configuration parameter used in the current livestreaming at the live stream host end, and “illumination, screen brightness and volume configuration” corresponding to relevant hardware configuration parameters of the live stream host end and an external illumination device. In addition, the parameter selection interface further includes prompt information “share configuration to audience” configured for prompting to select the configuration parameter.

In an embodiment, the operation of displaying the parameter identifier of at least one configuration parameter related to the livestreaming content on the parameter selection interface includes: determining a content type of the livestreaming content; determining the second arrangement order of a plurality of configuration parameters related to the livestreaming content according to the content type; and displaying a parameter identifier of the plurality of configuration parameters related to the livestreaming content in the parameter selection interface according to the second arrangement order.

In this embodiment, in order to conveniently and accurately share the configuration parameter of the live stream host end to an audience end, according to the content type of the livestreaming content, the arrangement order of the parameter identifiers in the parameter selection interface is determined.

When responding to the configuration sharing operation, firstly, the content type (such as various content types including game livestreaming, teaching livestreaming, and chat livestreaming, which may be defined by those skilled in the art according to practical requirements) of the livestreaming content is firstly determined. The content type of the livestreaming content may be acquired through content analysis on the livestreaming content, and may also be determined according to a type mark of the virtual livestreaming room configured by the live stream host.

After the content type of the livestreaming content is determined, further according to an association degree between the configuration parameter corresponding to the livestreaming content and the content type of the livestreaming content, the arrangement order of the parameter identifier of the configuration parameter related to the livestreaming content is determined, and is recorded as the second arrangement order. For example, an arrangement position of the parameter identifier of the configuration parameter related to the livestreaming content may be determined according to an order of the association degree from high to low. That is, the parameter identifier with the higher association degree between an indicated configuration parameter and the livestreaming content has the front arrangement position.

Exemplarily, during the game livestreaming, the content type of the livestreaming content is correspondingly determined as “game”, the livestreaming content may simultaneously include the playing content of the game application and a figure content of the live stream host, the configuration parameter related to the livestreaming content may include the game application configuration parameter, the beautification configuration parameter and the hardware configuration parameter (such as the screen brightness and the volume level) of the live stream host end, of course, at this moment, an association degree between the game application configuration parameter and the livestreaming content is the highest, an association degree between the hardware configuration parameter of the live stream host end and the livestreaming content is medium, and an association degree between the beautification configuration parameter and the livestreaming content is the lowest.

In some embodiments, after the second arrangement order of the parameter identifier of the configuration parameter related to the livestreaming content is determined, according to the second arrangement order, the parameter identifiers are displayed in the parameter selection interface, and displayed parameter identifiers are sequenced according to the second arrangement order of the configuration parameters identified by the parameter identifiers.

Operation 230: A target configuration parameter indicated by a selected parameter identifier is sent to audience ends used by at least some of the audiences of the virtual livestreaming room in response to a selection operation for the parameter identifier in the parameter selection interface.

The target configuration parameter is a configuration parameter identified by the selected parameter identifier. The audiences in the virtual livestreaming room are audiences participating in livestreaming in the virtual livestreaming room. The at least some of the audiences refer to one or a plurality of audiences in all audiences in the virtual livestreaming room. The live stream host may select to send the target configuration parameter to one or some or all audiences. The live stream host end or a livestreaming server may store the target configuration parameter into a standard format file according to a preset format, so as to share the target configuration parameter to the audience ends, and the audience ends may read the standard format file according to the preset format to acquire the target configuration parameter shared by the live stream host.

On one hand, based on the parameter identifier displayed in the parameter selection interface, the live stream host may determine to select and share which configuration parameter to the audience ends in the virtual livestreaming room by himself, and may also select and share the configuration parameter to the audience ends of the virtual livestreaming room in response to the demands of the audience ends in the virtual livestreaming room. In response to the selection operation for the parameter identifier in the parameter selection interface, the configuration parameter indicated by the selected parameter identifier is determined as a target configuration parameter to be shared, and is correspondingly sent to the audience ends of the virtual livestreaming room. The target configuration parameter is at least one. For example, the live stream host may select the game application configuration parameter to be used as the target configuration parameter, and may simultaneously select the game application configuration parameter, the beautification configuration parameter, etc. to be used as the target configuration parameter.

On the other hand, after the audience end receives the target configuration parameter shared by the live stream host end, the target configuration parameter may be applied to the audience end to configure the audience end. For example, the livestreaming content at the live stream host end is a playing content of a game application, the game application configuration parameter of the game application is correspondingly shared to the audience end of the virtual livestreaming room, the game application configuration parameter shared by the live stream host end is applied to the audience end, and the visual and/or auditory effect the same as or similar to that in the live stream host end may be acquired. For another example, the livestreaming content at the live stream host end is a video chat content of the live stream host, the beautification configuration parameter of the live stream host is correspondingly shared to the audience end of the virtual livestreaming room, the beautification configuration parameter shared by the live stream host end is applied to the audience end, and the audience may acquire the beautification effect the same or similar to that of the live stream host end when starting the livestreaming by himself or making a voice chat with the live stream host.

An operation type of the selection operation aiming at the parameter identifier in the parameter selection interface in this embodiment is not limited. For example, the operation type may be a touch click/tap operation aiming at the parameter identifier, a mouse click/tap operation, a keyboard selection operation and a voice selection operation such as a voice instruction “select a specific parameter identifier”, etc.

The implementation of the livestreaming is based on the virtual livestreaming room created by the livestreaming server, the live stream host end transmits the livestreaming content to the livestreaming server, and then, the livestreaming server dispenses the livestreaming content to the audience ends adding to the virtual livestreaming room to realize the livestreaming. Correspondingly, in this embodiment, in order to lower the configuration sharing cost, a livestreaming link may be reused to realize the sharing of the configuration parameter.

Referring to FIG. 6, in response to the selection operation for the parameter identifier in the parameter selection interface, the selected target configuration parameter may be dispensed to the audience ends of the virtual livestreaming room through the livestreaming server.

In an exemplary embodiment, in order to realize more accurate configuration sharing, the operation of in response to the selection operation for the parameter identifier in the parameter selection interface, sending the target configuration parameter indicated by the selected parameter identifier to the audience ends of the virtual livestreaming room includes: displaying, in response to the selection operation of the parameter identifier in the parameter selection interface, the audience selection interface and displaying the audience identifiers of the audiences in the virtual livestreaming room on the audience selection interface; and sending, in response to the selection operation for the audience identifier in the audience selection interface, the target configuration parameter indicated by the selected parameter identifier to the audience ends indicated by the selected audience identifiers.

In this embodiment, the capability of freely selecting the audience ends to be shared is provided for the live stream host end, so that the live stream host end may select the audience ends to be shared according to practical requirements, more accurate configuration sharing is realized, and the problem of resource waste caused by repeated operation due to inaccurate sharing is avoided.

Different from the above embodiments, in this embodiment, when there is a selection operation for the parameter identifier in the parameter selection interface, in response to this selection operation, the configuration parameter corresponding to the selected parameter identifier is determined as a target configuration parameter and the audience selection interface is displayed, and the audience selection interface includes the audience identifiers corresponding to the audiences in the virtual livestreaming room. The audience identifier uniquely expresses the audience end, and may include an audience end image identifier (such as a head portrait), and a character identifier (such as a nickname). The display form of the audience selection interface is not specifically limited in this embodiment. A display parameter of the audience selection interface, such as a display position, a display style, mobility, and transparency, may be defined according to requirements.

When there is a selection operation on the audience identifier in the audience interface, the audience end indicated by the selected audience identifier is determined to the audience end requiring configuration parameter sharing, and the target configuration parameter indicated by the selected parameter identifier is correspondingly sent to the audience end indicated by the selected audience identifier.

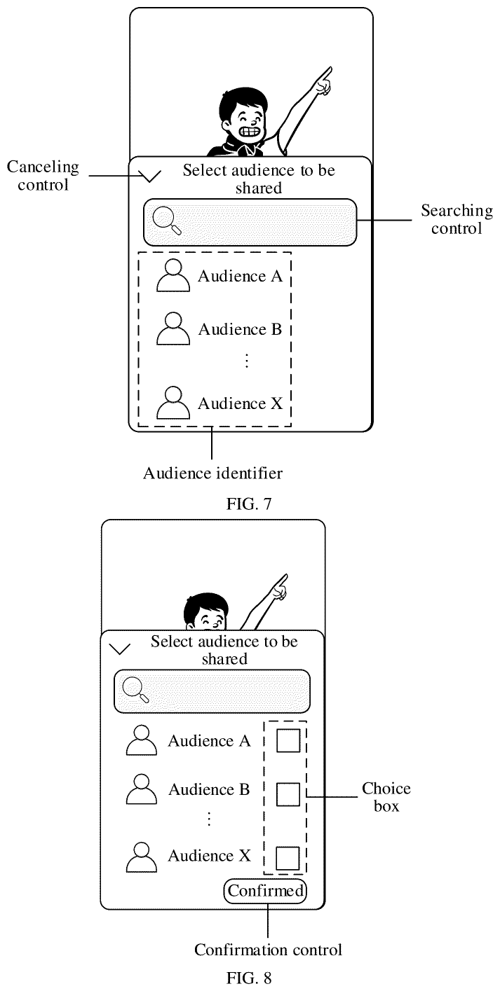

Exemplarily, referring to FIG. 7, an audience selection interface is shown, as shown in FIG. 7, the audience identifiers of some of audiences in the virtual livestreaming room and prompt information “select an audience to be shared” of prompting to select the audience end are shown in the audience selection interface, and the live stream host end may change the audience identifiers of the displayed audiences in response to an audience switching operation (such as a slide touch operation for the audience selection interface) for the audience selection interface. In addition, the audience selection interface further includes a searching control and a canceling control. The searching control is configured to provide a searching function for the audience end so that the live stream host fast finds the audience end to be shared, and the canceling control is configured to indicate to stop displaying the audience selection interface when being triggered.

When the audience identifier of the audience expected to share the configuration by the live stream host is displayed in the audience selection interface, the live stream host end may trigger the selection operation of the audience identifier of the audience expected to share the configuration. At least one audience may be selected as the audience requiring configuration parameter sharing.

As shown in FIG. 7, the live stream host end displays the audience selection interface in a single-option mode by default, and the live stream host may trigger the selection operation for the audience identifier of the single audience expected for configuration sharing. For example, the live stream host may short press the audience identifier of the audience expected for sharing in a touch mode to trigger the selection operation for the audience identifier. In response of this selection operation, the live stream host end determines the audience end indicated by the selected audience identifier as the audience end requiring the configuration parameter sharing.

In addition, the live stream host end further provides an audience selection interface in a multi-option mode. Referring to FIG. 8, different from the single-option mode as shown in FIG. 7, the audience selection interface further includes a choice box associated with the audience identifier and a determination control, the choice box is configured to select the audience identifier, and the determination control generates the selection operation for the selected audience identifier when being triggered. The multi-option mode of the audience selection interface may be triggered by a long-press operation of the live stream host end in response to the audience identifier for the audience selection interface, or a mode switching control is singly set, and the switching between the single-option mode and the multi-option mode is triggered through the mode switching control.

In an exemplary embodiment, in order to further improve the configuration sharing accuracy, the operation of displaying the audience identifiers of the audiences in the virtual livestreaming room in the audience selection interface includes: determining a demand degree of the audiences in the virtual livestreaming room on the target configuration parameter; determining the first arrangement order of the audience identifiers of the audiences in the virtual livestreaming room according to a corresponding demand degree of the audiences in the virtual livestreaming room; and displaying the audience identifiers of the audiences in the virtual livestreaming room in the audience selection interface according to the first arrangement order.

The electronic device may determine the demand degree of the audiences in the virtual livestreaming room on the target configuration parameter. According to the demand degree corresponding to the audiences in the virtual livestreaming room, the first arrangement order of the audience identifiers corresponding to the audiences in the virtual livestreaming room is determined. According to the first arrangement order, the audience selection interface is displayed.

In this embodiment, in order that the live stream host end may conveniently, fast and accurately share the configuration parameter to the audience end with a sharing demand, according to the demand degree of the audience end on the configuration parameter, the arrangement order of the audience identifiers is determined, the live stream host end may determine the demand degree of the audiences in the virtual livestreaming room on the target configuration parameter according to a configured demand degree evaluation strategy, and the configuration of the demand degree evaluation strategy is not specifically limited therein.

After the corresponding demand degree of the audiences in the virtual livestreaming room is determined, according to the corresponding demand degree of the audiences in the virtual livestreaming room, the arrangement order of the audience identifiers corresponding to the audiences in the virtual livestreaming room in the audience selection interface is determined, and is recorded as the first arrangement order.

Corresponding to the display order on the audience selection interface, for any two audiences in the virtual livestreaming room, the arrangement position of the audience identifier corresponding to the audience end with the higher demand degree may be determined, and is positioned in front of the arrangement position of the audience identifier corresponding to the audience end with the lower demand degree; and the arrangement position of the audience identifier corresponding to the audience end with the higher demand degree may also be determined to be positioned behind the arrangement position of the audience identifier corresponding to the audience end with the lower demand degree.

Generally, the first arrangement order of the audience identifiers corresponding to the audience ends may be correspondingly determined according to the demand degree of the audience ends from high to low, and the first arrangement order of the audience identifiers corresponding to the audience ends may be correspondingly determined according to the demand degree of the audience ends from low to high.

As mentioned above, after the first arrangement order of the audience identifiers corresponding to the audiences in the virtual livestreaming room is determined, the audience selection interface is displayed according to the first arrangement order, and the arrangement order of the audience identifiers in the audience selection interface is the first arrangement order. By adopting the solution of this embodiment, the audiences may be recommended to the live stream host according to the demand degree, the live stream host may select the audience to share the configuration parameter according to the demand, the accuracy of a sharing target is further ensured, and the resource waste caused by sharing the configuration parameter with the audience with no demand is avoided.

In an exemplary embodiment, the operations of providing an exemplary demand degree evaluation strategy and determining the demand degree of the audiences in the virtual livestreaming room on the target configuration parameter include: determining a virtual resource transferred by the audiences in the virtual livestreaming room; and determining the demand degree of the audiences in the virtual livestreaming room on the target configuration parameter according to the virtual resource transferred by the audiences in the virtual livestreaming room.

In this embodiment, the demand degree of the audience ends on the target configuration parameter may be indicated by the virtual resource transferring from the audience ends to the live stream host end.

The virtual resource is a resource in any one form capable of being transmitted in a network, and is measured by “amount”. The virtual resource may be electronic money corresponding receipts and payments, the amount may be the amount of receipts and payments (e.g., the value of the electronic money involved in receipts and payments), and the receipts and payments realize the transferring of the electronic money between users based on a mobile payment technology. The virtual resource may be a virtual article (or may also be called as a gift), such as a virtual sports car, a virtual lighter, a virtual flower, a piece of virtual cake, and a piece of virtual diamond, and a user of the livestreaming platform may buy the virtual article at a livestreaming platform with legal tender, and may give the bought virtual article to the live stream host.

In this embodiment, the live stream host end firstly determines the virtual resource transferred by the audiences in the virtual livestreaming room, e.g., the virtual resource transferred from the audience account of the audience end to the live stream host account of the live stream host end, and determines the demand degree of the audiences in the virtual livestreaming room on the target configuration parameter according to the account of the virtual resource transferred by the audiences in the virtual livestreaming room. The determined demand degree and the amount of the virtual resource are in positive correlation. That is, for one audience end, the great amount of the virtual resource transferred by the audience end correspondingly determines the higher demand degree of the audience end on the target configuration parameter.

In other embodiments, the demand degree of the audience end on the target configuration parameter may further be determined according to interaction information sent by the audience end. For example, the interaction information sent by the audience end may be subjected to semantic recognition through a semantic recognition model, the demand degree of the audience end on the target configuration parameter is determined according to the obtained semantic recognition result. For example, interaction information “I want a configuration parameter of a certain application very much” shows higher demand degree on the configuration parameter on the certain application than interaction information “I want a configuration parameter of a certain application”.

In an exemplary embodiment, the operation of in response to the selection operation for the audience identifiers in the audience selection interface, sending the target configuration parameter indicated by the selected parameter identifier to the audience end indicated by the selected audience identifier includes: exporting, in response to the selection operation for the audience identifiers in the audience selection interface, the target configuration parameter indicated by the selected parameter identifier from a source application according to a configuration file format of the source application being a source of the livestreaming content and sending the target configuration parameter indicated by the selected parameter identifier to the audience end indicated by the selected audience identifier. In another embodiment, the operation of in response to the selection operation for the audience identifier in the audience selection interface, sending the target configuration parameter indicated by the selected parameter identifier to the audience end indicated by the selected audience identifier includes: acquiring, in response to the selection operation for the audience identifier in the audience selection interface, the target configuration parameter indicated by the selected parameter identifier from the source application and sending the target configuration parameter indicated by the selected parameter identifier to the audience end indicated by the selected audience identifier according to a format of a key-value pair.

In this embodiment, according to a condition whether the source application being a source of the livestreaming content supports the configuration file import/export or not, the response is performed for the selection operation of the audience identifier in the audience selection interface in different modes.

If the source application being a source of the livestreaming content supports the configuration file import/export, when the live stream host end is in response to the selection operation for the audience identifier in the audience selection interface, according to the configuration file format of the source application, through a configuration file export interface provided by the source application, the target configuration parameter indicated by the selected parameter identifier is exported from the source application, and the exported target configuration parameter is sent to the audience end indicated by the selected audience identifier. Correspondingly, the audience end requiring configuration parameter sharing may provide an import interface of a configuration file provided by the audience end and the application the same as the source application to directly import the target configuration parameter from the live stream host end for realizing the application of the target configuration parameter.

If the source application being the source of the livestreaming content does not support the import/export of the configuration file, when the live stream host end is in response to the selection operation of the audience identifier for the audience selection interface, through the configuration parameter interface provided by the source application, the target configuration parameter indicated by the selected parameter identifier is read from the source application, and a read target configuration parameter is sent to the audience end indicated by the selected audience identifier at a format of a key-value pair. Correspondingly, the audience end requiring configuration parameter sharing may display the target configuration parameter at the format of the key-value pair, the audience of the audience end requiring configuration parameter sharing needs to manually apply the target configuration parameter, or the target audience end generates a corresponding simulation configuration operation instruction according to the target configuration parameter at the format of the key-value pair, and executes the configuration operation of simulation input of the corresponding target configuration parameter via the simulation configuration operation instruction, and the application of the target configuration parameter is realized.

From the above, in the present disclosure, the livestreaming content of the virtual livestreaming room is displayed; in response to the configuration sharing operation, the parameter selection interface is displayed, and the parameter selection interface includes the parameter identifier of at least one configuration parameter related to the livestreaming content; and in response to the selection operation for the parameter identifier in the parameter selection interface, the target configuration parameter indicated by the selected parameter identifier is sent to the audience end of the virtual livestreaming room. Compared with the related art, the present disclosure provides a new sharing channel of the configuration parameter, e.g., sharing from the live stream host end to the audience end realized based on the virtual livestreaming room. Different live stream hosts are skilled in different fields, and the parameter configuration performed by the live stream hosts to provide the livestreaming content with good audio-visual effect is a type of experience accumulation of the live stream hosts in the field. After joining in the livestreaming, the audience end may obtain the configuration parameter shared by the live stream host from the live stream host end to realize the experience and knowledge inheritance of the live stream hosts in the relevant fields, and the good audio-visual effect may be obtained without the need of mastering the parameter configuration skill by the audience. The configuration sharing and propagation may be realized without the need of specially-assigned persons or the waste of long time, the operation efficiency is high, and the cost is low.

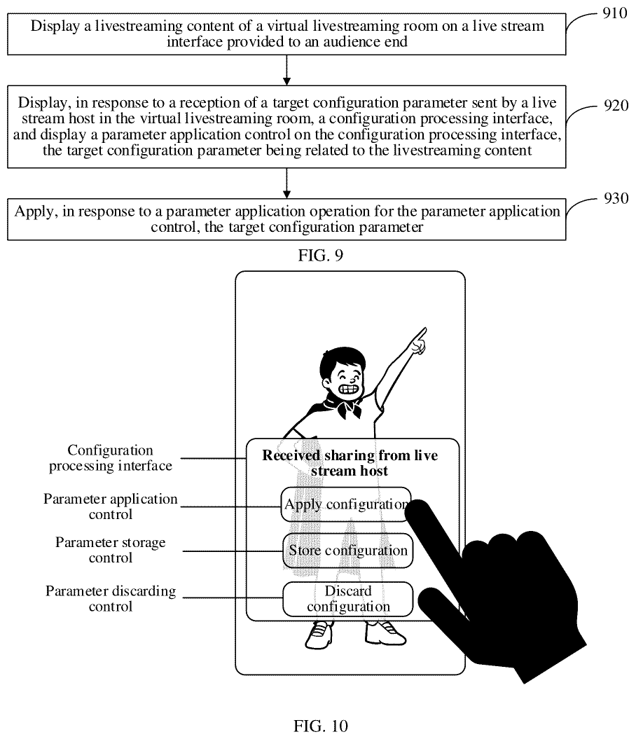

Referring to FIG. 9, FIG. 9 is another schematic flowchart of a configuration parameter sharing method provided by the present disclosure. In the following embodiment, the electronic device executes the configuration parameter sharing method as an identity of the audience end. As shown in FIG. 9, a flow process of the configuration parameter sharing method provided by the present disclosure may further be as follows:

Operation 910: A livestreaming content of a virtual livestreaming room is displayed on a live stream interface provided to an audience end.

In this embodiment, an audience may log in a livestreaming application program of the electronic device with an audience account, so that the electronic device is used as the audience end.

The livestreaming content of the virtual livestreaming room is displayed on the audience end. Generally, the livestreaming content includes a visual content and an auditory content. The visual content may be displayed through a visual content display assembly (such as a screen) in response to the audience end, and the auditory content may be displayed through an auditory content display assembly. By taking the visual content as an example, the audience end may display a live stream interface of the virtual livestreaming room through the visual content display assembly, and the live stream interface includes the visual content in the livestreaming content.

The live stream interface may be an interface configured to realize visual content display and livestreaming interaction. That is, the live stream interface may be logically divided into a livestreaming region and an interaction region. The livestreaming region is configured to display the visual content of the livestreaming content, the interaction region is configured to display an interaction operation control realizing livestreaming interaction, such as a thumbs-up control, a comment control, and a sharing control. The livestreaming region and the interaction region of the live stream interface may be set in an overlapped manner, and may also be set independently.

Operation 920: A configuration processing interface is displayed in response to a reception of a target configuration parameter sent by a live stream host in the virtual livestreaming room, and a parameter application control is displayed on the configuration processing interface, the target configuration parameter being related to the livestreaming content.

The electronic device used as the audience end may display the configuration processing interface in response to a reception of the target configuration parameter sent by the live stream host end of the virtual livestreaming room. The configuration processing interface includes a parameter application control, and the target configuration parameter is a configuration parameter related to the livestreaming content.

In this embodiment, the live stream host end shares the target configuration parameter to the audience in the virtual livestreaming room, and the target configuration parameter is the configuration parameter related to the livestreaming content. For example, when game livestreaming is implemented at the live stream host end, the livestreaming content at least includes a game content (including a visual content such as a game image of a game application, and an auditory content such as game background sound) of a live stream host playing the game application, and at this moment, target configuration parameters capable of being shared include an application configuration parameter of the game application, and a hardware configuration parameter (such as an operation frequency of a processor, a screen brightness, and a volume level) of the live stream host end. For another example, when chat livestreaming is implemented at the live stream host end, the livestreaming content at least includes a chat content (including a visual content such as a figure image of the live stream host, and an auditory content such as chat voice of the live stream host), at this moment, target configuration parameters capable of being shared include an image acquisition configuration parameter of an image acquisition assembly, a beautification configuration parameter for beautification optimization on an image content acquired by the image acquisition assembly, an audio acquisition configuration parameter of an audio acquisition assembly, an illumination configuration parameter of an external auxiliary device such as an illumination device, etc. The image acquisition assembly may be an image acquisition assembly outside the live stream host end, and may also be an image acquisition assembly built in the live stream host end; and the audio acquisition assembly may be an audio acquisition assembly outside the live stream host end, and may also be an audio acquisition assembly built in the live stream host end.

The live stream host end may display the parameter selection interface in response to the configuration sharing operation, and the parameter identifier of at least one configuration parameter related to the livestreaming content is displayed on the parameter selection interface. In response to the selection operation for the parameter identifier in the parameter selection interface, the target configuration parameter indicated by a selected parameter identifier is sent to the audience ends used by at least some of audiences in the virtual livestreaming room. Relevant descriptions in the above embodiments of the configuration parameter sharing method applicable to the live stream host end may be taken as references, and they are not repeated therein.

In this embodiment, when the condition that the audience end receives the target configuration parameter sent from the live stream host end in the virtual livestreaming room, the configuration processing interface is displayed as the response. The configuration processing interface is configured to provide a processing function on a received target configuration parameter. Display modes of the configuration processing interface are not specifically limited, and they may be set by those skilled in the art according to practical requirements.

For example, the audience end may display the configuration processing interface in an overlapped manner on the live stream interface of the virtual livestreaming room in a mode of a floating window, so that the audience may select how to process the received target configuration parameter. The configuration processing interface is displayed through the floating window, so the audience may be timely and observably prompted without excessive interference on the live stream interface. A display parameter of the floating window, such as a display position, a display style, mobility, and transparency, may be defined according to requirements.

Exemplarily, referring to FIG. 10, a configuration processing interface displayed in a mode of a floating window is shown. As shown in FIG. 9, the configuration processing interface is overlapped on the visual content of the live stream interface in a mode of a floating window, and a current processing control for processing operation on the target configuration parameter including a parameter application control, a parameter storage control, and a parameter discarding control, is displayed. The parameter application control is configured to generate a parameter application operation when being triggered. The parameter storage control is configured to generate a parameter storage operation when being triggered. The parameter discarding control is configured to generate a parameter discarding operation when being triggered. In addition, as shown in FIG. 10, the configuration processing interface further includes prompt information “received the sharing from the live stream host” for prompting the reception of the target configuration parameter from the live stream host end, prompt information “apply configuration” for indicating the processing control being the parameter application control, prompt information “store configuration” for indicating the processing control being the parameter storage control, and prompt information “apply configuration” for indicating the processing control being the parameter discarding control.

Operation 930: The target configuration parameter is applied in response to a parameter application operation for the parameter application control.

In this embodiment, when the audience of the audience end has an application demand on the target configuration parameter shared from the live stream host end, the parameter application operation may be triggered based on the parameter application control displayed in the configuration processing interface. Correspondingly, in response to the parameter application operation for the parameter application control, the target configuration parameter is applied to the audience end.

For example, when the target configuration parameter shared by the live stream host end is a hardware configuration parameter such as the screen brightness and the volume level, the audience end may call a parameter configuration interface provided by the system to apply the hardware configuration parameter shared by the live stream host end to the audience end. For another example, when the target configuration parameter shared by the live stream host end is a beautification configuration parameter, the audience end may configure the beautification configuration parameter to the audience end, so as to acquire the beautification effect the same as or similar to that of the live stream host end when starting the livestreaming by himself or making a video call with the live stream host. For another example, when the target configuration parameter shared by the live stream host end is a configuration parameter of another application (application other than the livestreaming application), if the target configuration parameter is at the configuration file format, and another application is the application supporting the configuration file import and export, the target configuration parameter at the configuration file format may be imported through the configuration file import interface provided by another application, and the application of the target configuration parameter is realized. If the target configuration parameter is not at the configuration file format, or another application is the application not supporting the configuration file import and export, an operation instruction of a simulation configuration operation is generated according to the target configuration parameter, and a generated operation instruction is executed to simulate the configuration operation and apply the target configuration parameter to another application.

In other embodiments, after the target configuration parameter is applied in response to the parameter application operation based on the parameter application control, the operation further includes: recovering, in response to a triggered parameter roll-back operation, a historical configuration parameter before the application of the target configuration parameter.

Before the application of the target configuration parameter to the audience end, a current applied corresponding configuration parameter is firstly recorded, and then, the target configuration parameter is applied. After the audience applies the target configuration parameter shared from the live stream host end, a parameter roll-back operation may be triggered if the audience feels that the target configuration parameter is inappropriate or unneeded. Correspondingly, in response to the parameter roll-back operation, the audience end restores a historical configuration parameter before the application of the target configuration parameter, e.g., the configuration parameter corresponding to the above record.

In other embodiments, after the configuration processing interface is displayed, the operation further includes: storing, in response to the parameter storage operation of the parameter storage control, the target configuration parameter.

In other embodiments, after the configuration processing interface is displayed, the operation further includes: discarding, in response to the parameter discarding operation of the parameter discarding control, the target configuration parameter.

The audience of the audience end may not need application of the target configuration parameter shared from the live stream host end, or may temporarily not need application of the target configuration parameter shared from the live stream host end.

The audience of the audience end may trigger the parameter storage operation based on the parameter storage control displayed in the configuration processing interface when temporarily not needing application of the target configuration parameter shared from the live stream host end. Correspondingly, in response to the parameter storage operation, the audience end stores a received target configuration parameter to a preset storage path, or stores the received target configuration parameter to a specified storage path indicated by the parameter storage operation.

In addition, the audience of the audience end may trigger the parameter discarding operation based on the parameter discarding control displayed in the configuration processing interface when not needing application of the target configuration parameter shared from the live stream host end. Correspondingly, in response to the parameter discarding operation, the audience end directly discards the received target configuration parameter.

The audience in the virtual livestreaming room may have a device in a different type from the live stream host end. For example, the live stream host end may be a mobile phone, and the audience end may be a computer. At this moment, the target configuration parameter shared from the live stream host end may not be directly applied to the audience end. Based on the above, in an exemplary embodiment, in order to improve an application success ratio of a shared target configuration parameter, the target configuration parameter application includes: directly applying the target configuration parameter if a current audience end supports the target configuration parameter; and

forwarding the target configuration parameter to an external associated device supporting the target configuration parameter if the current audience end does not support the target configuration parameter, and indicating the external associated device to apply the target configuration parameter.

In this embodiment, if the current audience end supports the target configuration parameter, the audience end directly applies the target configuration parameter. Otherwise, the target configuration parameter is forwarded to an external associated device supporting the target configuration parameter, and the external associated device is indicated to apply the target configuration parameter.

When the audience end and the live stream host end are devices of the same type, the audience end will support the target configuration parameter shared by the live stream host end. At this moment, the target configuration parameter may be directly applied. Relevant description in the above embodiments may be taken as references for details, and they are not repeated herein.

In addition, when the audience end and the live stream host end are devices of different types, the audience end will not support the target configuration parameter shared by the live stream host end. At this moment, the target configuration parameter is forwarded to an external associated device (such as other devices belonging to the audience and being in the same type as the live stream host end) supporting the target configuration parameter, and the external associated device is indicated to apply the target configuration parameter. For example, the live stream host end is a computer, the audience end is a mobile phone, the shared target configuration parameter is a game application configuration parameter of an A game application running on the computer, and it is clear that the audience end will not support the target configuration parameter. At this moment, the audience end forwards a received game application configuration parameter to the computer of the audience, and the game application configuration parameter is applied to the A game application of the audience end by the computer of the audience.

Referring to FIG. 11, FIG. 11 is a further another schematic flowchart of a configuration parameter sharing method provided by the present disclosure. In the following embodiment, the illustration is provided from perspectives of the live stream host end and the audience end at the same time. As shown in FIG. 11, the configuration parameter sharing method provided by the present disclosure may further be as follows:

Operation 1110: A live stream host end displays a livestreaming content of a virtual livestreaming room, and the livestreaming content is sent to an audience end to be displayed through a livestreaming server.

In this embodiment, for the livestreaming content generated by the live stream host end, on one hand, the live stream host end sends the livestreaming content to the audience end of the virtual livestreaming room to be displayed through the livestreaming server to realize the livestreaming; and on the other hand, the live stream host end per se also displays the livestreaming content of the virtual livestreaming room to provide the real-time livestreaming feedback for the live stream host, so that the live stream host masters a livestreaming effect.

Operation 1120: The audience end transfers a virtual resource to the live stream host end through the livestreaming server.

The virtual resource is a resource in any one form capable of being transmitted in a network, and is measured by “amount”. The virtual resource may be electronic money corresponding receipts and payments, the amount may be the amount of receipts and payments (e.g., the value of the electronic money involved in receipts and payments), and the receipts and payments realize the transferring of the electronic money between users based on a mobile payment technology. The virtual resource may be a virtual article (or may also be called as a gift), such as a virtual sports car, a virtual lighter, a virtual flower, a piece of virtual cake, and a piece of virtual diamond, and a user of the livestreaming platform may buy the virtual article at a livestreaming platform with legal tender, and may give the bought virtual article to the live stream host.

In this embodiment, the audience end transfers the virtual resource to the live stream host end through the livestreaming server so as to express the demand on the configuration parameter corresponding to the livestreaming content. For example, game livestreaming is implemented at the live stream host end, the livestreaming content is a playing content of a certain game application played by the live stream host, the audience of the audience end discovers that the audio-visual effect of the playing content of the game application played by the live stream host is enjoyed by himself and is expected to be acquired by himself, the audience end may be operated to transfer a virtual resource to the live stream host end through the livestreaming server, for example, a virtual article such as a virtual sports car or a virtual lighter may be given to a male live stream host, or a virtual article such as a virtual flower or a piece of virtual diamond may be given to a female live stream host.

In addition, in order to clearly show the demand of the audience on the configuration parameter corresponding to the livestreaming content, the audience end sends a demand indication while transferring the virtual resource to the live stream host end through the live streaming server, and the demand indication is configured for indicating the demand of the audience on the target configuration parameter in the configuration parameter corresponding to the livestreaming content.

Operation 1130: The live stream host end displays a parameter selection interface in response to a configuration sharing operation.

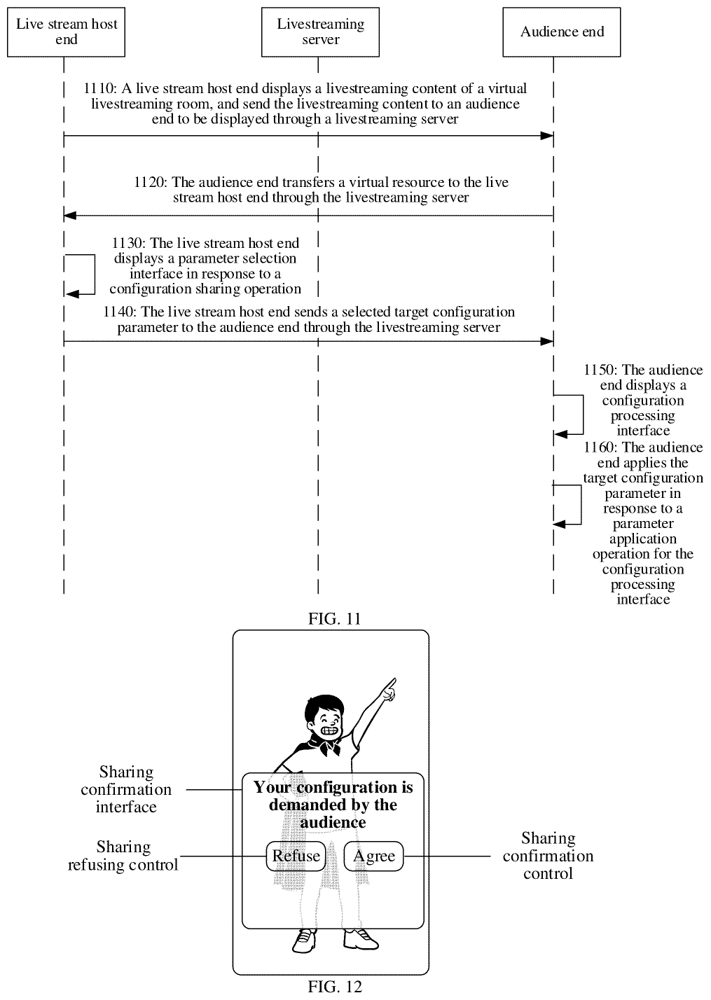

When the live stream host end receives the demand indication and the virtual resource transferred by the audience end through the livestreaming server, the audience of the audience end is judged to have the demand on the configuration parameter corresponding to the livestreaming content. At this moment, the live stream host end displays a sharing confirmation interface. Referring to FIG. 12, the sharing confirmation interface includes a sharing confirmation control and a sharing refusing control. The sharing confirmation control is configured to generate the configuration sharing operation when being triggered. The sharing refusing control is configured to indicate to stop displaying the sharing confirmation interface when being triggered. In addition, the sharing confirmation interface further includes prompt information “your configuration is demanded by the audience” configured for prompting the demand of the audience on the configuration parameter of the livestreaming content.

If agreeing to share, the live stream host may trigger the configuration sharing operation based on the sharing confirmation control. Correspondingly, in response to a configuration sharing operation, the live stream host end displays the parameter selection interface. The parameter selection interface is configured to provide a parameter selection function, and includes a parameter identifier of at least one configuration parameter corresponding to the livestreaming content in the virtual livestreaming room.

For example, when game livestreaming is implemented at the live stream host end, the livestreaming content at least includes a game content (including a visual content such as a game image of a game application, and an auditory content such as game background sound) of a live stream host playing the game application, and at this moment, configuration parameters capable of being shared include an application configuration parameter of the game application, and a hardware configuration parameter (such as an operation frequency of a processor, a screen brightness, and a volume level) of the live stream host end; and

for another example, when chat livestreaming is implemented at the live stream host end, the livestreaming content at least includes a chat content (including a visual content such as a figure image of the live stream host, and an auditory content such as chat voice of the live stream host) of the live stream host, at this moment, the configuration parameters capable of being shared include an image acquisition configuration parameter of an image acquisition assembly, a beautification configuration parameter for beautification optimization on the image content acquired by the image acquisition assembly, an audio acquisition configuration parameter of an audio acquisition assembly, an illumination configuration parameter of an external auxiliary device such as an illumination device, etc. The image acquisition assembly may be an image acquisition assembly outside the live stream host end, and may also be an image acquisition assembly built in the live stream host end; and the audio acquisition assembly may be an audio acquisition assembly outside the live stream host end, and may also be an audio acquisition assembly built in the live stream host end.

Display modes of the parameter selection interface are not specifically limited in this embodiment, and they may be configured by those skilled in the art according to practical requirements.

Operation 1140: The live stream host end sends a selected target configuration parameter to the audience end through the livestreaming server.

Based on the parameter identifier displayed in the parameter selection interface, the live stream host may select the target configuration parameter demanded by the audience in response to the demand of the audience and share the target configuration parameter to the audience end. Correspondingly, in response to the selection operation for the parameter identifier corresponding to the target configuration parameter in the parameter selection interface, the live stream host end sends the target configuration parameter to the audience end through the livestreaming server.

Operation 1150: The audience end displays a configuration processing interface.

In this embodiment, when the condition that the audience end receives the target configuration parameter sent from the live stream host end in the virtual livestreaming room, the configuration processing interface is displayed as the response. The configuration processing interface is configured to provide a processing function on a received target configuration parameter. Display modes of the configuration processing interface are not specifically limited, and they may be set by those skilled in the art according to practical requirements.

For example, the audience end may display the configuration processing interface in an overlapped manner on the live stream interface of the virtual livestreaming room in a mode of a floating window, so that the audience may select how to process the received target configuration parameter. The configuration processing interface is displayed through the floating window, so the audience may be timely and observably prompted without excessive interference on the live stream interface. A display parameter of the floating window, such as a display position, a display style, mobility, and transparency, may be defined according to requirements.

The configuration processing interface includes a processing control capable of currently performing a processing operation on the target configuration parameter, including a parameter application control, a parameter storage control, and a parameter discarding control. The parameter application control is configured to generate a parameter application operation when being triggered. The parameter storage control is configured to generate a parameter storage operation when being triggered. The parameter discarding control is configured to generate a parameter discarding operation when being triggered.

Operation 1160: The audience end applies the target configuration parameter in response to a parameter application operation for the configuration processing interface.

For example, when the target configuration parameter is a hardware configuration parameter such as the screen brightness and the volume level at the live stream host end, the audience end may call a parameter configuration interface provided by the system to apply the hardware configuration parameter shared by the live stream host end to the audience end. For another example, when the target configuration parameter is a beautification configuration parameter at the live stream host end, the audience end may configure the beautification configuration parameter to the audience end, so as to acquire the beautification effect the same as or similar to that of the live stream host end when starting the livestreaming by himself or making a video call with the live stream host. For another example, when the target configuration parameter is a configuration parameter of another application (application other than the livestreaming application), if the target configuration parameter is at the configuration file format, and another application is the application supporting the configuration file import and export, the target configuration parameter at the configuration file format may be imported through the configuration file import interface provided by another application, and the application of the target configuration parameter is realized. If the target configuration parameter is not at the configuration file format, or another application is the application not supporting the configuration file import and export, an operation instruction of a simulation configuration operation is generated according to the target configuration parameter, and a generated operation instruction is executed to simulate the configuration operation and apply the target configuration parameter to another application.

In order to better implement the configuration parameter sharing method applicable to the live stream host end provided by the present disclosure, embodiments of the present disclosure further provide a corresponding configuration parameter sharing apparatus. Nouns have meanings the same as those in the above configuration parameter sharing method applicable to the live stream host end. The descriptions in the above embodiments of the configuration parameter sharing method applicable to the live stream host end may be taken as reference for specific implementation details.

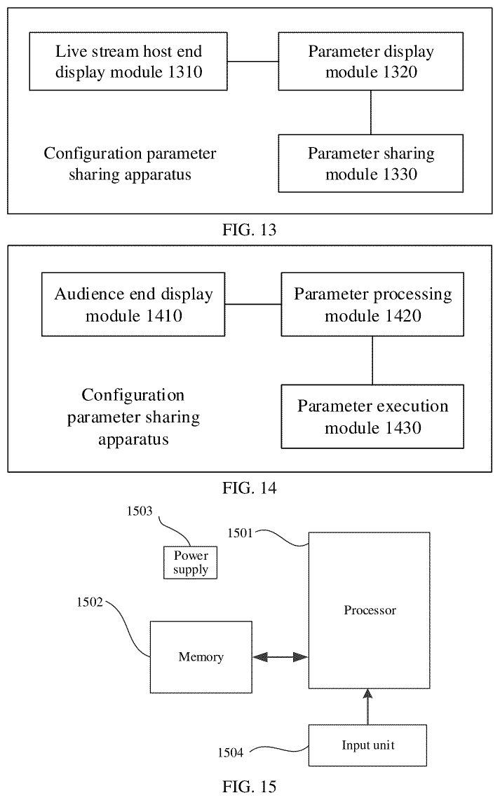

Referring to FIG. 13, FIG. 13 is a schematic structural diagram of a configuration parameter sharing apparatus provided by an embodiment of the present disclosure. The configuration parameter sharing apparatus may include a live stream host end display module 1310, a parameter display module 1320, and a parameter sharing module 1330.

The live stream host end display module 1310 is configured to display a livestreaming content of a virtual livestreaming room on a live stream interface provided to a live stream host.

The parameter display module 1320 is configured to display a parameter selection interface in response to a configuration sharing operation, and display a parameter identifier of at least one configuration parameter related to the livestreaming content on the parameter selection interface.

The parameter sharing module 1330 is configured to in response to a selection operation for the parameter identifier in the parameter selection interface, send a target configuration parameter indicated by a selected parameter identifier to audience ends used by at least some of the audiences of the virtual livestreaming room.

In an exemplary embodiment, the parameter sharing module 1330 is configured to display the audience selection interface in response to the selection operation for the parameter identifier in the parameter selection interface, so as to display the audience identifier of the audiences in the virtual livestreaming room in the audience selection interface; and send the target configuration parameter indicated by the selected parameter identifier to the audience ends indicated by the selected audience identifier in response to the selection operation of the audience identifier in the audience selection interface.

In an exemplary embodiment, the parameter sharing module 1330 is configured to determine the demand degree of the audiences in the virtual livestreaming room on the target configuration parameter; determine the first arrangement order of the audience identifiers of the audiences in the virtual livestreaming room according to the corresponding demand degree of the audiences in the virtual livestreaming room; and display the audience identifiers of the audiences in the virtual livestreaming room in the audience selection interface according to the first arrangement order.

In an exemplary embodiment, the parameter sharing module 1330 is configured to determine a virtual resource transferred by the audiences in the virtual livestreaming room; and determine the demand degree of the audiences in the virtual livestreaming room on the target configuration parameter according to the virtual resource transferred by the audiences in the virtual livestreaming room.

In an exemplary embodiment, the parameter sharing module 1330 is configured to export, in response to the selection operation for the audience identifiers in the audience selection interface, the target configuration parameter indicated by the selected parameter identifier from a source application according to a configuration file format of the source application being a source of the livestreaming content and send the target configuration parameter indicated by the selected parameter identifier to the audience ends indicated by the selected audience identifiers.

In an exemplary embodiment, the parameter sharing module 1330 is configured to acquire, in response to the selection operation for the audience identifiers in the audience selection interface, the target configuration parameter indicated by the selected parameter identifier from the source application and send the target configuration parameter indicated by the selected parameter identifier to the audience ends indicated by the selected audience identifiers according to a format of a key-value pair.

In an exemplary embodiment, the parameter display module 1320 may be configured to display the parameter selection interface through a floating window in response to the configuration sharing operation.

In an exemplary embodiment, the parameter display module 1320 may be configured to determine a content type of the livestreaming content; determine the second arrangement order of a plurality of configuration parameters related to the livestreaming content according to the content type; and display the parameter identifier of a plurality of configuration parameters related to the livestreaming content in the parameter selection interface according to the second arrangement order.

For the specific implementation of each of the above modules, the above embodiments may be taken as references, so they are not repeated therein.

In this embodiment, the livestreaming content of the virtual livestreaming room is displayed by the live stream host end display module 1310. In response to a configuration sharing operation, a parameter selection interface is displayed by the parameter display module 1320. The parameter selection interface includes the parameter identifier of at least one configuration parameter related to the livestreaming content, and in response to the selection operation for the parameter identifier in the parameter selection interface, the target configuration parameter indicated by the selected parameter identifier is sent by the parameter sharing module 1330 to audience ends in the virtual livestreaming room. Compared with the related art, the present disclosure provides a new sharing channel of the configuration parameter, e.g., sharing from the live stream host end to the audience end realized based on the virtual livestreaming room. Different live stream hosts are skilled in different fields, and the parameter configuration performed by the live stream hosts to provide the livestreaming content with good audio-visual effect is a type of experience accumulation of the live stream hosts in the field. After joining in the livestreaming, the audience end may obtain the configuration parameter shared by the live stream host from the live stream host end to realize the experience and knowledge inheritance of the live stream hosts in the relevant fields, and the good audio-visual effect may be obtained without the need of mastering the parameter configuration skill by the audience. In addition, the sharing of the configuration parameter may be realized through the virtual livestreaming room, the sharing flexibility of the configuration parameter may be further improved, the objective may be achieved without the need of specially-assigned persons or the waste of long time, the operation efficiency is high, and the cost is low.

In order to better implement the configuration parameter sharing method applicable to the audience end provided by the present disclosure, embodiments of the present disclosure further provide a corresponding configuration parameter sharing apparatus. Nouns have the same meanings as those in the above configuration parameter sharing method applicable to the audience end. For specific implementation details, the descriptions in the above method embodiments may be taken as references.

Referring to FIG. 14, FIG. 14 is another schematic structural diagram of a configuration parameter sharing apparatus provided by an embodiment of the present disclosure. The configuration parameter sharing apparatus may include an audience end display module 1410, a parameter processing module 1420 and a parameter execution module 1430.

The audience end display module 1410 is configured to display a livestreaming content of a virtual livestreaming room on a live stream interface provided to audience ends.

The parameter processing module 1420 is configured to display a configuration processing interface in response to a reception of a target configuration parameter sent by a live stream host in the virtual livestreaming room, and display a parameter application control on the configuration processing interface, the target configuration parameter being related to the livestreaming content.

The parameter execution module 1430 is configured to apply the target configuration parameter in response to a parameter application operation for the parameter application control.

In an exemplary embodiment, a parameter storage control is further displayed on the configuration processing interface, and the parameter execution module 1430 further stores the target configuration parameter in response to a parameter storage operation for the parameter storage control.

In an exemplary embodiment, a parameter discarding control is further displayed on the configuration processing interface, and the parameter execution module 1430 is further configured to discard the target configuration parameter in response to a parameter discarding operation for the parameter discarding control.

In an exemplary embodiment, the parameter execution module 1430 is configured to directly apply the target configuration parameter if a current audience end supports the target configuration parameter; and forward, if the current audience end does not support the target configuration parameter, the target configuration parameter to an external associated device supporting the target configuration parameter, and indicate the external associated device to apply the target configuration parameter.

For the specific implementation of each of the above modules, the above embodiments may be taken as references, so they are not repeated therein.

An embodiment of the present disclosure further provides an electronic device, including a memory and a processor. The processor is configured to implement the operations in the configuration parameter sharing method provided in this embodiment through calling a computer program stored in the memory.

Referring to FIG. 15, FIG. 15 is a schematic structural diagram of an electronic device provided by an embodiment of the present disclosure.

The electronic device may include components such as a processor 1501 with one or more processing cores, a memory 1502 of one or more computer-readable storage media, a power supply 1503, and an input unit 1504. The structure of the electronic device shown in FIG. 15 does not constitute limitation to the electronic device. The electronic device may include more or fewer components than those shown in the figure, may combine some components, or may have different component arrangements. In the figure:

the processor 1501 is a control center of the electronic device, and is connected to various parts of the entire electronic device via various interfaces and lines. The processor executes various functions of the electronic device and performs data processing by running or executing a software program and/or a module stored in the memory 1502 and calling data stored in the memory 1502. In one embodiment, the processor 1501 may include one or more processing cores. In one embodiment, the processor 1501 may integrate an application processor and a modem processor. The application processor mainly processes an operating system, a user interface, an application program, etc. The modem processor mainly processes wireless communication. The above modem processor may not be integrated into the processor 1501.

The memory 1502 may be configured to store a software program and a module. The processor 1501 runs the software program and the module stored in the memory 1502 to implement various functional applications and data processing. The memory 1502 may mainly include a program storage area and a data storage area. The program storage area may store an operating system, an application program required by at least one function (such as a sound playback function and an image playback function), etc. The data storage area may store data created according to use of the electronic device. In addition, the memory 1502 may include a high-speed random access memory, and may also include a non-volatile memory such as at least one magnetic disk storage device, a flash memory, or another volatile solid-state storage device. Correspondingly, the memory 1502 may further include a memory controller, so as to provide access of the processor 1501 to the memory 1502.

The electronic device further includes a power supply 1503 for supplying power to each component. In one embodiment, the power supply 1503 may be logically connected to the processor 1501 through a power supply management system, so as to realize functions such as management charging, discharging, and power consumption management through the power supply management system. The power supply 1503 may further include one or more of any assemblies of a direct current or alternating current power supply, a re-charging system, a power supply failure detection circuit, a power supply converter or inverter, a power supply state indicator, etc.

The electronic device may further include an input unit 1504. The input unit 1504 may be configured to receive input numeric or character information and generate keyboard, mouse, joystick, and optical or trackball signal input related to user settings and function control.

Although not shown, the electronic device may further include a display unit, an image acquisition assembly, etc. Details are not described herein. Specifically, in this embodiment, when the electronic device is used as an identity of the live stream host end, the processor 1501 may load an executable code corresponding to one or more computer programs into the memory 1502, and the processor 1501 executes the operations in the configuration parameter sharing method applicable to the live stream host end provided by the present disclosure. For example, the livestreaming content of the virtual livestreaming room is displayed on the live stream interface provided to the live stream host; the parameter selection interface is displayed in response to the configuration sharing operation; he parameter identifier of at least one configuration parameter related to the livestreaming content is displayed on the parameter selection interface; and the target configuration parameter indicated by the selected parameter identifier is sent to audience ends used by at least some of the audiences of the virtual livestreaming room in response to the selection operation for the parameter identifier in the parameter selection interface.

In addition, when the electronic device is used as an identity of a server, the processor 1501 may load an executable code corresponding to one or more computer programs into the memory 1502, and the processor 1501 executes operations in the configuration parameter sharing method applicable to the server provided by the present disclosure. For example, the livestreaming content of the virtual livestreaming room is displayed on the live stream interface provided to the audience end; the configuration processing interface is displayed in response to the reception of the target configuration parameter sent by the live stream host in the virtual livestreaming room; and the parameter application control is displayed on the configuration processing interface, the target configuration parameter being related to the livestreaming content; and the target configuration parameter is applied in response to the parameter application operation for the parameter application control.

The electronic device provided by embodiments of the present disclosure and the configuration parameter sharing method in the embodiments above belong to the same conception. For the specific implementation process, the above embodiments may be taken as references. Details are not repeated herein again.

The present disclosure further provides a computer-readable storage medium having a computer program stored therein, and when the computer program is executed by a processor of an electronic device provided by embodiments of the present disclosure, the processor of the electronic device implements operations of the configuration parameter sharing method provided by the present disclosure. The storage medium may be a magnetic disc, an optical disc, a read-only memory (ROM), a random access memory (RAM), etc.

The present disclosure further provides a computer program product including a computer program, and when the computer program is executed by a processor of an electronic device provided by embodiments of the present disclosure, the processor of the electronic device implements operations of the configuration parameter sharing method provided by the present disclosure.

When the above embodiments of the present disclosure are applied to a specific product or technology, permission or consent from the owner of a video work to which a video clip belongs needs to be obtained. In addition, for user-related data, permission or consent from the user needs to be obtained, and the collection, use and processing of relevant data shall comply with the relevant laws, regulations, and standards of the relevant countries and regions.

Each of technical features of the above embodiments may be combined in different manners to form other embodiments. For conciseness of description, not all possible combinations of each of technical features of the above embodiments are described. However, these technical features are to be considered to be within the scope recorded in this specification as long as there is no conflict in combinations of these technical features.

The above embodiments only describe several implementations of the present disclosure, which are described specifically and in detail, but cannot be construed as a limitation to the patent scope of the present disclosure. For a person of ordinary skill in the art, several modifications and improvements may be made without departing from the idea of the present disclosure, and these modifications and improvements all fall within the protection scope of the present disclosure. Therefore, the protection scope of the present disclosure shall be defined by the protection scope of claims appended hereto.

What is claimed is:

1. A configuration parameter sharing method, executed by an electronic device, and comprising:
displaying a livestreaming content of a virtual livestreaming room on a live stream interface, the live stream interface being provided to a live stream host;
displaying, in response to a configuration sharing operation, a parameter selection interface;
displaying, on the parameter selection interface, a parameter identifier of at least one configuration parameter related to the livestreaming content; and
sending, in response to a selection operation for the parameter identifier in the parameter selection interface, a target configuration parameter indicated by the selected parameter identifier to audience ends, the audience ends being used by at least some of audiences of the virtual livestreaming room.

2. The configuration parameter sharing method according to claim 1, wherein sending, in response to the selection operation for the parameter identifier in the parameter selection interface, the target configuration parameter indicated by the selected parameter identifier to audience ends, the audience ends being used by at least some of the audiences of the virtual livestreaming room comprises:
displaying, in response to the selection operation for the parameter identifier in the parameter selection interface, an audience selection interface;
displaying audience identifiers of the audiences in the virtual livestreaming room in the audience selection interface; and
sending, in response to a selection operation for the audience identifiers in the audience selection interface, the target configuration parameter indicated by the selected parameter identifier to the audience ends indicated by the selected audience identifiers.

3. The configuration parameter sharing method according to claim 2, wherein displaying audience identifiers of the audiences in the virtual livestreaming room in the audience selection interface comprises:
determining a demand degree of the audiences in the virtual livestreaming room on the target configuration parameter;
determining, according to the demand degree of the audiences in the virtual livestreaming room, a first arrangement order of the audience identifiers of the audiences in the virtual livestreaming room; and
displaying, according to the first arrangement order, the audience identifiers of the audiences in the virtual livestreaming room in the audience selection interface.

4. The configuration parameter sharing method according to claim 3, wherein determining, according to the demand degree of the audiences in the virtual livestreaming room, the first arrangement order of the audience identifiers of the audiences in the virtual livestreaming room comprises:
determining a virtual resource transferred by the audiences in the virtual livestreaming room; and
determining the demand degree of the audiences in the virtual livestreaming room on the target configuration parameter according to the virtual resource transferred by the audiences in the virtual livestreaming room.

5. The configuration parameter sharing method according to claim 2, wherein sending, in response to the selection operation for the audience identifiers in the audience selection interface, the target configuration parameter indicated by the selected parameter identifier to the audience ends indicated by selected audience identifiers comprises:
exporting, in response to the selection operation for the audience identifiers in the audience selection interface and according to a configuration file format of a source application being a source of the livestreaming content, the target configuration parameter indicated by the selected parameter identifier from the source application; and
sending the target configuration parameter indicated by the selected parameter identifier to the audience ends indicated by the selected audience identifiers.

6. The configuration parameter sharing method according to claim 2, wherein sending, in response to the selection operation for the audience identifiers in the audience selection interface, the target configuration parameter indicated by the selected parameter identifier to the audience ends indicated by selected audience identifiers comprises:
acquiring, in response to the selection operation for the audience identifiers in the audience selection interface, the target configuration parameter indicated by the selected parameter identifier from a source application; and
sending, according to a format of a key-value pair, the target configuration parameter indicated by the selected parameter identifier to the audience ends indicated by the selected audience identifiers.

7. The configuration parameter sharing method according to claim 1, wherein displaying, in response to the configuration sharing operation, the parameter selection interface comprises:
displaying, in response to the configuration sharing operation, the parameter selection interface through a floating window.

8. The configuration parameter sharing method according to claim 1, wherein displaying, on the parameter selection interface, the parameter identifier of at least one configuration parameter related to the livestreaming content comprises:
determining a content type of the livestreaming content;
determining, according to the content type, a second arrangement order of a plurality of configuration parameters related to the livestreaming content; and
displaying, according to the second arrangement order, parameter identifiers of the plurality of configuration parameters related to the livestreaming content in the parameter selection interface.

9. A configuration parameter sharing method, executed by an electronic device, and comprising:
displaying a livestreaming content of a virtual livestreaming room on a live stream interface, the live stream interface being provided to an audience end;
displaying, in response to a reception of a target configuration parameter sent by a live stream host in the virtual livestreaming room, a configuration processing interface;
displaying a parameter application control on the configuration processing interface, the target configuration parameter being related to the livestreaming content; and
applying, in response to a parameter application operation for the parameter application control, the target configuration parameter.

10. The configuration parameter sharing method according to claim 9, wherein a parameter storage control is further displayed on the configuration processing interface, and the method further comprises:
storing, in response to a parameter storage operation for the parameter storage control, the target configuration parameter.

11. The configuration parameter sharing method according to claim 9, wherein a parameter discarding control is further displayed on the configuration processing interface, and the method further comprises:
discarding, in response to a parameter discarding operation for the parameter discarding control, the target configuration parameter.

12. The configuration parameter sharing method according to claim 9, wherein applying, in response to the parameter application operation for the parameter application control, the target configuration parameter comprises:
directly applying the target configuration parameter when a current audience end supports the target configuration parameter; and
forwarding the target configuration parameter to an external associated device supporting the target configuration parameter when the current audience end does not support the target configuration parameter, and indicating the external associated device to apply the target configuration parameter.

13. A configuration parameter sharing apparatus, comprising a memory for storing instructions and a processor for executing the instructions to: display a livestreaming content of a virtual livestreaming room on a live stream interface, the live stream interface being provided to a live stream host;
display, in response to a configuration sharing operation, a parameter selection interface;
display, on the parameter selection interface, a parameter identifier of at least one configuration parameter related to the livestreaming content; and
send, in response to a selection operation for the parameter identifier in the parameter selection interface, a target configuration parameter indicated by the selected parameter identifier to audience ends, the audience ends being used by at least some of audiences of the virtual livestreaming room.

14. The configuration parameter sharing apparatus of claim 13, wherein the processor, when being configured to send, in response to the selection operation for the parameter identifier in the parameter selection interface, the target configuration parameter indicated by the selected parameter identifier to audience ends, the audience ends being used by at least some of the audiences of the virtual livestreaming room, is configured to execute the instructions to:
display, in response to the selection operation for the parameter identifier in the parameter selection interface, an audience selection interface;
display audience identifiers of the audiences in the virtual livestreaming room in the audience selection interface; and
send, in response to a selection operation for the audience identifiers in the audience selection interface, the target configuration parameter indicated by the selected parameter identifier to the audience ends indicated by the selected audience identifiers.

15. The configuration parameter sharing apparatus of claim 14, wherein the processor, when being configured to display audience identifiers of the audiences in the virtual livestreaming room in the audience selection interface, is configured to execute the instructions to:
determine a demand degree of the audiences in the virtual livestreaming room on the target configuration parameter;
determine, according to the demand degree of the audiences in the virtual livestreaming room, a first arrangement order of the audience identifiers of the audiences in the virtual livestreaming room; and
display, according to the first arrangement order, the audience identifiers of the audiences in the virtual livestreaming room in the audience selection interface.

16. The configuration parameter sharing apparatus of claim 15, wherein the processor, when being configured to determine, according to the demand degree of the audiences in the virtual livestreaming room, the first arrangement order of the audience identifiers of the audiences in the virtual livestreaming room, is configured to execute the instructions to:
determine a virtual resource transferred by the audiences in the virtual livestreaming room; and
determine the demand degree of the audiences in the virtual livestreaming room on the target configuration parameter according to the virtual resource transferred by the audiences in the virtual livestreaming room.

17. The configuration parameter sharing apparatus of claim 14, wherein the processor, when being configured to send, in response to the selection operation for the audience identifiers in the audience selection interface, the target configuration parameter indicated by the selected parameter identifier to the audience ends indicated by selected audience identifiers, is configured to execute the instructions to:
export, in response to the selection operation for the audience identifiers in the audience selection interface and according to a configuration file format of a source application being a source of the livestreaming content, the target configuration parameter indicated by the selected parameter identifier from the source application; and
send the target configuration parameter indicated by the selected parameter identifier to the audience ends indicated by the selected audience identifiers.

18. A non-transitory computer readable medium storing a plurality of instructions, wherein the plurality of instructions, when executed by a processor, configure the processor to perform the operations in the method according to claim 1.

19. A configuration parameter sharing apparatus, comprising a memory for storing instructions and a processor for executing the instructions to perform the operations in the method according to claim 9.

20. A non-transitory computer readable medium storing a plurality of instructions, wherein the plurality of instructions, when executed by a processor, configure the processor to perform the operations in the method according to claim 9.
